(19) United States
(12) Patent Application Publication
(10) Pub. No.: US 2005/0196039 A1
(43) Pub. Date: Sep. 8, 2005

(54) Method for color determination using a digital camera

(76) Inventors: Wolfgang Bengel, Bensheim (DE); Stephen J. Chu, New York, NY (US)

Correspondence Address: HOWARD C. MISKIN;C/O STOLL, MISKIN, & BADIE, THE EMPIRE STATE BUILDING, 350 FIFTH AVENUE SUITE 4710, NEW YORK, NY, 10118, US

(21) Appl. No.: 11/055,401

(22) Filed: Feb. 10, 2005

Related U.S. Application Data
(60) Provisional application No. 60/549,766, filed on Mar. 2, 2004.

(51) Int. Cl. G06K 9/00; G06K 9/36

(52) U.S. Cl. 382/162; 382/286

(57) ABSTRACT

A method for consistently determining color information of an object utilizing a high resolution digital image taken with a digital camera. The object is set in a fixed environmental and lighting condition and the digital camera is set with certain predetermined fixed settings to provide consistent and repeatable digital images. The digital image is taken with a predetermined neutral reference adjacent the object. A commercially available image editing software is used to standardize and analyze the color information of the digital image based on the neutral reference.

### CROSS-REFERENCE TO RELATED APPLICATIONS

This application claims the benefit of U.S. Provisional Patent Application Ser. No. 60/549,766 filed Mar. 2, 2004, which is hereby incorporated by reference.

### FIELD OF THE INVENTION

The present invention relates to a method of determining a specific color of any object utilizing a digital camera. In particular, a simple and cost effective method of determining tooth shade from a high resolution digital photograph utilizing commercially available software.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

The therapeutic outcome of tooth-bleaching procedures can be assessed by different methods. Existing methods of tooth shade analysis include the use of shade guide, colorimeter, spectrophotometer or digital photography. Shade guide is a set of predetermined color shade swatches, e.g. Vitapan®'s shade guide, that allows a dentist/technician to visually compare different color shade swatches with a patient's tooth by placing the swatch adjacent the patient's tooth. This type of tooth shade analysis is disadvantageously subject to many variables and subjective determinations. It is neither not standardized nor objective. The results vary depending on the lighting conditions, background effects, and the dentist's/technician's color visual acuity, binocular differences, fatigue of the retina, age, medications taken, etc. The problem with visual analysis is compounded by the inherent construction of the tooth. Each tooth is made up of the inner dentin, which is opaque and yellowish and the outer enamel, which is transparent and bluish. Light reflects and disperses when it hits the tooth, which causes the tooth to appear both translucent and opalescent. Translucency results when blue light (short wavelengths) is dispersed. Opalescency results when red-orange light (longer wavelengths) is transmitted. Other factors also affect visual tooth shade analysis: morphology, texture, gloss and color (hue, value, and chroma) of the tooth. Therefore, visual comparison is highly inaccurate.

Colorimeters and spectrophotometers provide more standard color analysis by using computer aided color selection. The goal of these devices is to eliminate surrounding and illumination influences to provide reproducible results that can be documented. A colorimeter measures light by breaking it down into its red-green-blue (RGB) components. A color's numeric value is then determined using the CIE XYZ color space or CIE Lab or CIE Luv values and is visually interpreted in a color space graph. Limitations of calorimeters include difficulty to read the monitor, difficulty to analyze lower teeth and cannot read composite resin material. A spectrophotometer measures spectral data, i.e. the amount of light energy reflected from an object at several intervals along the visible spectrum. These measurements provide a complex data set of reflectance valves which are visually interpreted in the form of a spectral curve. Spectrophotometers similarly have their limitations: an expensive system, can analyze anterior teeth only, difficult to analyze lower teeth and does not provide clinical pictures for records. Both of these types of electronic devices are generally expensive, technically sensitive and do not replace control by the human eye.

Although prior art digital photography has been used for tooth shade analysis, its accuracy and repeatability is poor because the photography fails to take into consideration the important factors such as light, camera technology and standardizing the procedure. Some prior art method uses the automatic mode of the photographic equipment, which results in non-repeatable and non-comparable images because the lighting condition and the procedure are not otherwise standardized. For example, an image taken in automatic mode for bright teeth will ordinarily be too dull and provide “false” information for analysis. Other prior art method uses a “motorized zoom lens,” which has no influence on the outcome of an image analysis. Also, determining each red-green-blue (RGB) value of each tooth pixel sounds impressive, but this is exactly what every CCD or CMOS chip does, even in low-costs digital cameras and does not improve the accuracy of the image. Some expensive prior art devices utilize digital images and proprietary software for analyzing the images, but fail to consider standardizing the condition and procedure of collecting the images.

Therefore, there is a need for a method for consistently determining color of an object using digital cameras that takes into consideration light, camera technology, a standardized procedure and the use of a commercially available standard image editing software to produce repeatable and comparable images for color analysis.

### BRIEF SUMMARY OF THE INVENTION

The method of the present invention provides a repeatable and definable process using digital photography from which color results can be compared.

The method of the present invention determines the specific color based on Lab values, which is a color industry standard, from a high resolution digital photograph or image using commercially available software. The digital photograph can be taken with any brand of digital SLR camera and advantageously, facilitates and lowers the cost of practicing the method of the present invention. The use of commercially available software to analyze the digital photographs also advantageously lowers the cost of practicing the method of the present invention.

In accordance with the method of the present invention, the digital photographs are taken under standardized conditions, including light condition, photographic equipment technology and settings of the photographic equipment to produce repeatable images. Although the resulting digital photographs minimize the color cast in the image, to further eliminate color cast and to adjust image brightness, a neutral reference point, such as a piece of gray card, is provided within the digital image. The gray card allows the image editing software to eliminate any remaining color cast that results despite standardized conditions and to adjust image brightness. Color values of the fine tuned image are then determined by the software and are available for comparison with other images taken under the same method of the present invention.

Due to the repeatability of the images using the method of the present invention, it is useful for assessing the therapeutic outcome of tooth-bleaching procedures and determining tooth shade during tooth restorative procedures.

The method of the present invention is simple, non-invasive, fast and reliable. The method is useful not only to the dental profession, but also for other medical and industrial fields, where color is important.

### BRIEF DESCRIPTION OF THE DRAWINGS

FIG. 1 illustrates the use of a small piece of gray card together with a black contraster put behind the teeth.

FIG. 2 is a screenshot of the ADOBE Photoshop® program surface.

FIG. 3 is a screenshot of the ADOBE Photoshop® illustrating an image is loaded for analysis.

FIG. 4 is a screenshot of the ADOBE Photoshop® illustrating the Levels menus is opened and the grey eye dropper is selected.

FIG. 5 is a screenshot of the ADOBE Photoshop® changing RGB values to Lab values.

FIG. 6 is a screenshot of the ADOBE Photoshop® illustrating the image brightness is changed to an L-value of 54 (grey card).

FIG. 7 is a screenshot of the ADOBE Photoshop® showing the selection of the tooth to be measured, with reflections excluded.

FIG. 8 is a screenshot of the ADOBE Photoshop® illustrating the metering of the L-value of the selected tooth by the Histogram function.

FIG. 9 is a screenshot of the ADOBE Photoshop® illustrating the metering of the a-value of the selected tooth by the Histogram function.

FIG. 10 is a screenshot of the ADOBE Photoshop® illustrating the metering of the L-value of the selected tooth by the Histogram function.

### DESCRIPTION OF THE PREFERRED EMBODIMENTS

Although the description below will be directed to tooth shade analysis, the method of the present invention is useful and applicable to analyze color of any objects.

Photography has been used for many years in an attempt to improve communication between dentists and dental technicians. Until recently no method was described that allowed dental photographs alone to replace shade selection by the dentist and/or the dental technician. Other methods had to be used to assess tooth color shade and brightness. Nevertheless, a photograph image provides the dental technician with a lot of information, including tooth morphology, surface texture, color distribution, luster, and other properties.

Interest in tooth-bleaching procedures has dramatically increased in recent years. Today bleaching is considered an integral part of esthetic dentistry. Initially conventional photographs were made using 35 mm slide film. Some researchers used slides in combination with secondary methods such as calorimeters to determine a clinically observable color change. Recently digital photography has started to replace conventional photography. Researchers have started to use digital cameras for the assessment of bleaching methods by generating a digital image and loading it into image editing software. This software provides numeric values of image color and brightness. Film-processing images then can be digitized and analyzed with commercial software (e.g. Adobe Photoshop®, Adobe Systems Incorporated, San Jose, Calif.). Although digitizing images taken from conventional film can be done, the results are less reliable. In additional to the technical variables such as light and camera technology, other factors affect images taken with conventional film (e.g. film type, number of film emulsion, storage conditions, the processing of the film, etc.). Therefore, in principal, methods using film that is later digitized cannot be more precise than methods using direct digital photography of the present invention as conventional methods add more variables to the process.

A reliable and repeatable method of determining color of an object with digital photography requires the use of comparable images. Many different factors determine whether comparable images are achievable. For example, photographic equipment, settings of the photographic equipment, and lighting condition all affect the resulting digital image brightness and color rendition. Therefore, a highly standardized photographic procedure is required.

Photographic Equipment

Digital cameras can be divided into three groups: amateur, semiprofessional and professional cameras. In dental photography, only semiprofessional and professional cameras should be used.

Although most dentists are satisfied with the results obtained with semiprofessional cameras, there are limitations. The most important limitation is that these cameras do not allow perfect image control since in most cases the liquid crystal display (LCD) screen has to be used as a viewfinder. As a result, there is no control over the position of the focusing plane and therefore, the depth of field. Very often one has to rely on the auto-focus function. Some cameras have a rather long lag time, which makes focusing difficult. The lighting of these systems is not variable and cannot be adapted to the situation. A major disadvantage in this context is that not all cameras of this group allow manual exposure and flash mode.

If professional results are expected and to provide better image control, professional digital SLR cameras are needed. Professional digital SLR cameras generally allow close-up range, interchangeable lenses, system flash, storage medium and power supply. It is convenient for a user of conventional SLR cameras to use digital SLR cameras because digital SLR cameras are based on conventional bodies such that interchangeable lenses and flash equipment for conventional SLR cameras of the same brand can be used for digital photography. Some examples of professional cameras adapted for use in dental photography include Nikon D1X®, Nikon D70®, Nikon D100®, Fuji FinePix S2 Pro®, Canon EOS 10D®, and 20D® and Sigma SD-10®.

The Nikon D1X® is a professional camera system that is based on a professional camera body; it is therefore rather expensive. It provides 5.5 MP images, 3 fps and has a firewire connection to a personal computer.

The Nikon D70® and D100® are 6.1 MP cameras based on the N80 body. Each provides good color rendition and connects to a personal computer by means of a USB cable.

The Fuji FinePix S2 Pro® is a another 6.1 MP (SuperCCD) camera based on the N80 Nikon body. It uses a firewire connection to a personal computer. TTL flash metering also works with Nikon macro flashes.

The Canon EOS 10D® and 20D® are 6.3 MP and 8.3 MP cameras, respectively, each with a CMOS sensor, ring flash, and twin flash with a eTTL metering. It works with a personal computer via a USB connection.

Sigma SD-10® is based on the Sigma SA-9® and contains a Foveon X3 sensor with a 3.5 MP resolution. Since every photo diode receives the whole color information, an X3 sensor can be compared with a conventional charge-coupled device (CCD) or CMOS sensor with a 7.8 MP image.

Lighting Condition

Different factors have influence on the color rendition and image brightness in digital photography, including lighting condition.

“Photography” means “writing/drawing with light.” One of the most important properties of light is its color temperature (i.e. the color of light radiated by a “black body,” expressed in degrees Kelvin). Unlike our brain, which adapts to different color temperatures and “sees” a white sheet of paper always as white, even when lit by a yellowish light source, a camera sees the color temperature as it is: neutral at 6500° K, yellowish at 2800 to 4000° K, and bluish at temperatures between 7000 and 9000° K.

Color temperature of daylight changes depending on the time of the day, the season, the weather, and the direction a window is facing. Therefore, daylight affects the color rendition of an image, causing a certain color cast. This is why color shade selection in the dental office should not be performed under daylight.

Room illumination affects color rendition as well. Very often fluorescent tubes are used that are designed to imitate daylight. Normally, they have no continuous spectrum and are not perfectly neutral. The dental operating lamp is another source of color cast. Often halogen bulbs are used in the lamp, which have a color temperature between 3000 and 3400° K, causing a yellowish cast. Light reflected from the clothing of the patient (as well as from that of the assistant and dentist), the walls, and the ceiling can cause a weak color cast. Therefore, neutral tones are recommended for use in the operating room.

The color temperature of the flash light itself is important. Powerful flash lights with a short flash duration time tend to be a little more bluish than are weak flash systems. Inadequate color temperature depends on the mixture of gases in the tube. The type of flash is important as well as it determines the lighting angle. A ring flash with axial light direction causes another color rendition as a side (point or a twin) flash. The amount of light fired by a flash and the consequent image brightness depend also on the charge the flash condensator has. Often the condensator is not recharged completely, even though the flash-ready LED indicates that the flash is set to fire again. It is important to wait another three or four seconds before taking the photo.

The influence of these factors cannot be avoided completely, but it can be minimized by the following measures:
Daylight should be blocked out (room without windows or at least facing north)
Neutral colors should be used for the ceiling, walls, and clothing.
A powerful flash should be used.
The aperture should be closed at least to stop 16 or 22.
The flash condensator should be given time to recharge completely.

Camera Technology

Camera technology also has influence on the color rendition and image brightness in digital photography. The term camera technology includes the lens, camera alignment and patient position, exposure mode, and camera sensor, etc.

Every lens has its own color characteristic, which depends on the type of glass used for the lens elements and the coating on their surfaces to prevent flare. As this characteristic does not change from one exposure to the next and as it has only a very weak influence, the color characteristic is not really a problem in this context. Since the lens has an indirect influence on color rendition, its focal length (working distance), together with the chosen magnification ratio, determines the working distance and thereby the lighting angle if a flash system is used that is fixed to the lens.

In the context of dental photography, camera alignment is important even though it is not a technical property of the camera but involves the handling of the camera. It is important to align the camera in a repeatable way. The optical axis of the camera should always be oriented according to the anatomic planes of the patient. It should be perpendicular to the patient's frontal plane and go over into the occlusal plane without an angle. Only in this way can one expect repeatable results concerning the inclination of the camera in relation to the front teeth. The use of a grid screen is used to facilitate alignment. A chin rest may also be used to stabilize the patient's position.

Modern cameras offer different exposure modes. Besides a manual exposure mode in which the aperture and exposure time can be preset manually, normally three automatic modes are available: aperture priority (the aperture is preselected, and the camera sets the exposure time automatically), shutter priority (the aperture is set by the camera after the shutter speed is set), and the program mode (both parameters are set by the camera). For the present invention, and in dental photography, the manual and the aperture priority modes are used. The principal problem with setting exposure modes is that the camera does not know what brightness an object has, whether it is very dark, very bright, or has a medium brightness level. Therefore, the exposure system of the camera always tries to generate a picture with a medium brightness value, corresponding with a medium gray tone. Consequently, very bright objects (e.g. a white cast) are reproduced darker, whereas dark objects are reproduced brighter. In these cases an exposure compensation has to be used to adjust the exposure. In the case of a bright object, light has to be added; if the object is dark, light has to be reduced. Therefore, an automatic exposure mode cannot be used to obtain reproducible results regarding tooth brightness.

To make matters more complicated, the different light meter characteristics of a camera (i.e. integral, spot, center weighted, and matrix metering) have an influence on image brightness too. In dental photography, spot metering system does not produce good results because the results depends on what is located within the limited small metering area. Matrix metering system take different image segments into account individually for light metering and works well for dental photography. Similarly, center-weighted metering system works well for dental photography. To obtain reproducible results for tooth shade analysis, the method of the present invention requires the exposure metering characteristic used to be consistent, with the use of manual exposure and flash modes (without TTL flash metering).

In a digital camera the image of an object is projected onto the surface of the sensor. One-layer sensors include CCD, Super CCD and CMOS. Three-layer sensor includes X3. As these sensors consist of millions of single photo elements, the image is split into millions of picture elements (pixels). Brightness is recorded for each single pixel and then transformed into an electric signal. Color is generated by internal data processing because photo diodes are colorblind. For this purpose most digital cameras use color mosaic filters. The exception is the X3 sensor from Foveon.

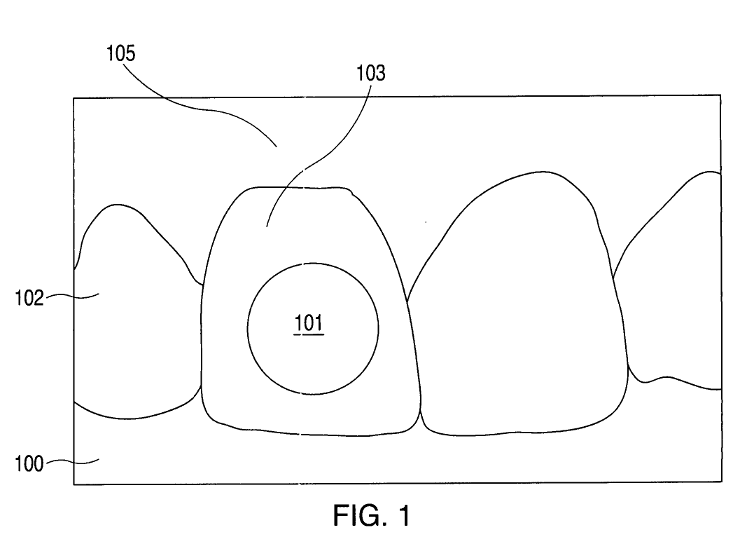

Color rendition and image brightness depend very much on the type of sensor, the filters that are used for generating color information, the computer algorithms, the white balance settings. Resulting images with the automatic white balance setting can differ based on the lighting condition. Therefore, automatic white balance setting is to be avoided for the method of the present invention. To get reproducible results concerning color rendition and image brightness when using a digital camera, the following is required:
Work in a consistent surrounding (e.g. same room, same lighting condition, etc.).
Use the same equipment (e.g. a digital SLR camera with macro lens and electronic flash).
Choose the same magnification ratio (e.g. as close to 1:1 as possible) to avoid any distortion.
Select a manual exposure (i.e. no automatic exposure mode; always preset the same aperture based on the same flash system's light output).
Select the manual flash mode (no TTL flash metering).
Select a fixed white balance (no automatic white balance).
Select the same image resolution (to allow consistency and reproducibility).
Select the same file type (TIFF or JPEG with same degree of image compression to allow consistency and reproducibility).
Set a low ISO value (e.g. ISO 100 or 125 to attain best image quality)
Put a black background 100 behind the teeth 102 to avoid differences of the semitransparent tooth owing to the tongue position of the patient, as shown in FIG. 1.
Use a standardized camera alignment.
Use the same metering characteristics—either center weighted or matrix.

Even if all the above rules are obeyed, there will be differences causing a color cast and a variability in image brightness. These are mostly due to a certain technical variability of the camera system (e.g. aperture opening or flash function). Therefore, a method must be used that allows the fine tuning of color rendition and image brightness.

### EXAMPLE OF SETTINGS OF PHOTOGRAPHIC EQUIPMENT

For the Nikon D100(camera body, a 105 mm AF Mikro Nikkor lens and the Nikon SB29s flash without diffuser, the following settings is used for the method of the present invention:
Exposure time: 1/125s
Aperture: F36
Magnification ratio: 1:1.2 (once focused, this ratio provides enough distance between the camera and the teeth to include the canines)
White balance: flash
Exposure compensation: 0
File format: jpeg
Metering characteristics: center weighted
ISO setting: 200 (lowest available for this camera)

It is important for the practice of the present invention that the same settings are used when photographs are taken. Therefore, it is preferred that these settings be fixed.

Reference Color

Even with the use of a highly standardized photographic procedure, other factors remain that affect color and brightness that cannot be excluded completely. Therefore, a piece of gray card is used. A gray card is a piece of cardboard or plastic with a surface that has a reflectance value of 18%. This represents the middle tone used for exposure determination, half way between pure black and pure white. It is the same tone of gray for which a camera meter is calibrated; therefore, a gray card is used for exposure metering. Also, the gray card is a neutral target, meaning the red, blue, and green values are equal. The idea behind the use of a gray card is to put something in the picture that has a known value, in other words, that we know to be pure gray, and then let the software make sure that that object is interpreted as grey. Thereby, a color cast of the whole picture is eliminated. The grey card serves two functions: (1) to eliminate possible color casts of the digital image caused by lighting conditions, camera technique, etc.; and (2) to allow “fine tuning” of the digital image brightness to get repeatable and comparable photographs. Both of these functions can be performed using a commercially available standard image editing program.

As normal gray cards available in the photographic stores, such as qpcard (available from http://www.qpcard.com), are too big to include into a 1:1 shot of the present invention, only a small piece of gray card 101 is used. It can be punched out using an office hole punch and fixed to the surface of a tooth 103 or to the gum area 105 adjacent a tooth with a small amount of petrolatum, to serve as an intraoral reference 101 as shown in FIG. 1. The gray card 101 can also be placed behind or in front of the tooth 103. Preferably, images are taken with the intraoral reference 101 at the same position each time to produce repeatable and comparable images.

Software Analysis

Commercially available standard image editing software such as ADOBE Photoshop®, from Adobe Systems Incorporated, San Jose, Calif., can be used to eliminate color casts and fine tune image brightness before the relevant color values are metered by the same software to compare photographic results.

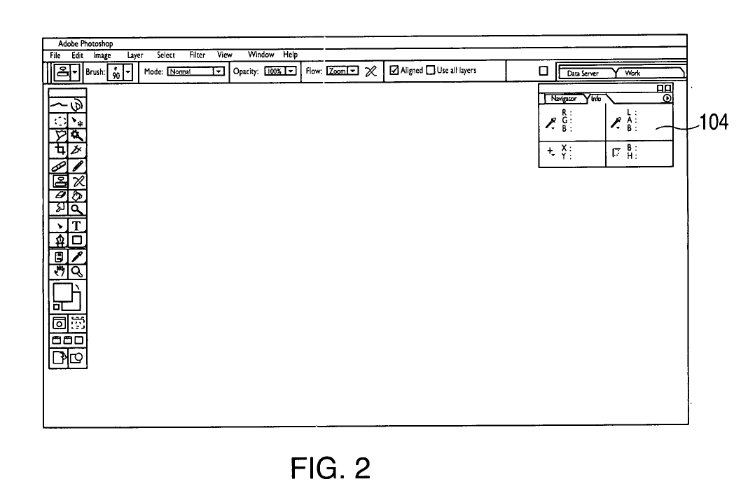

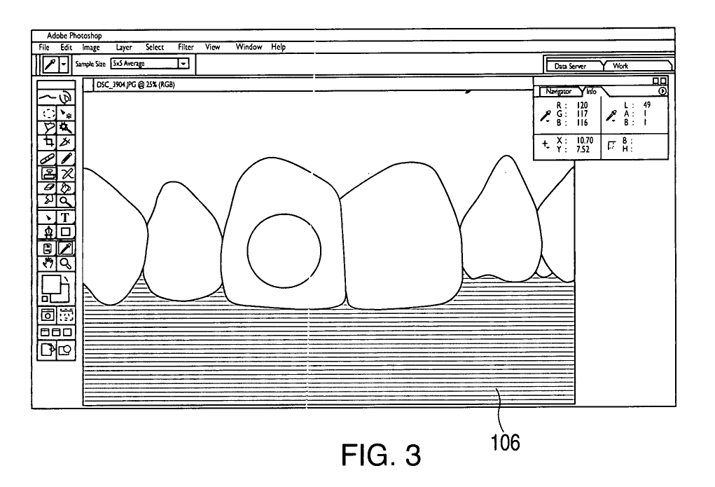

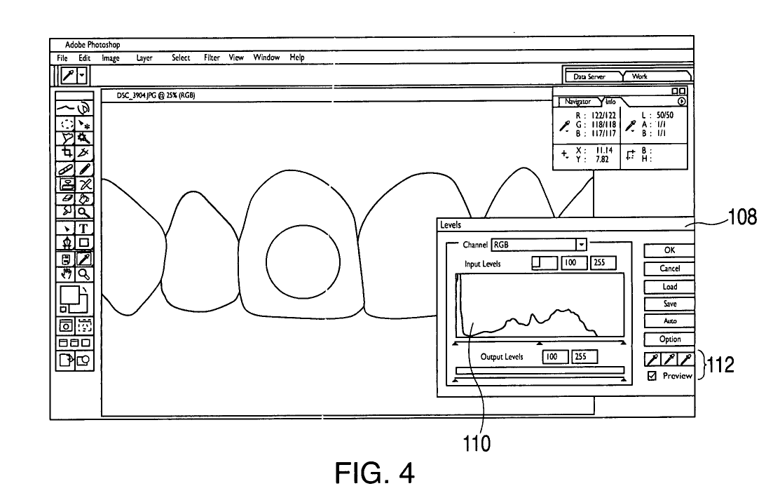

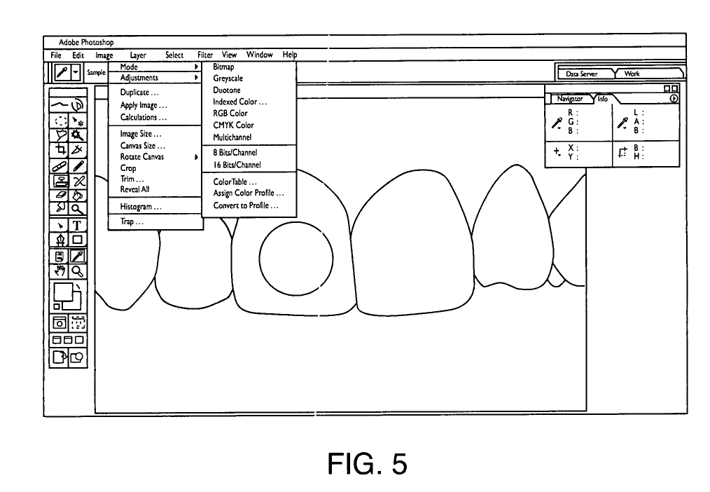

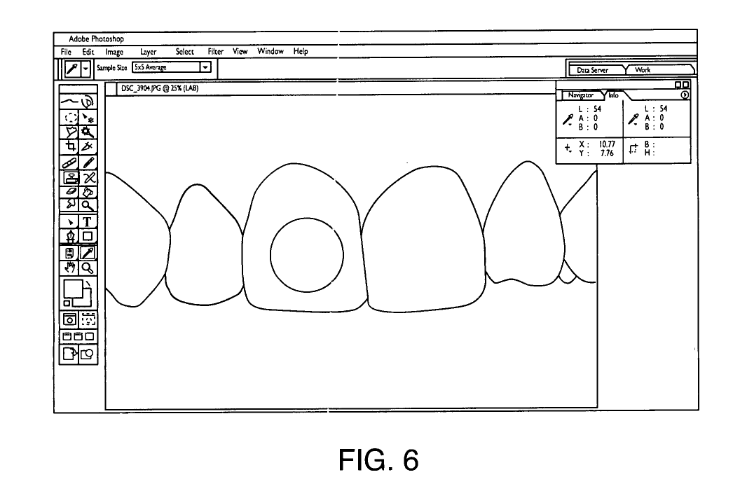

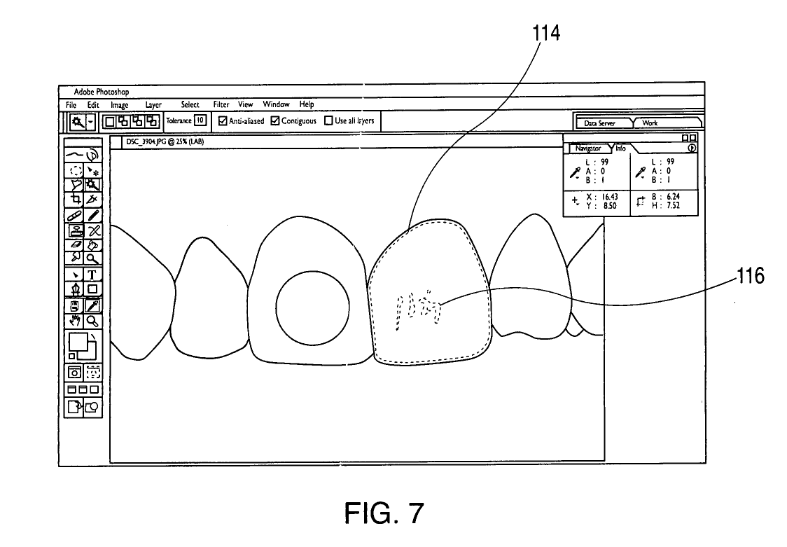

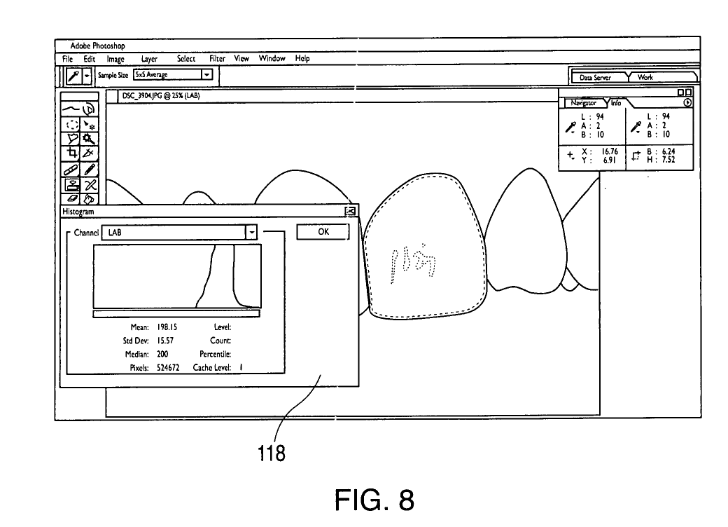

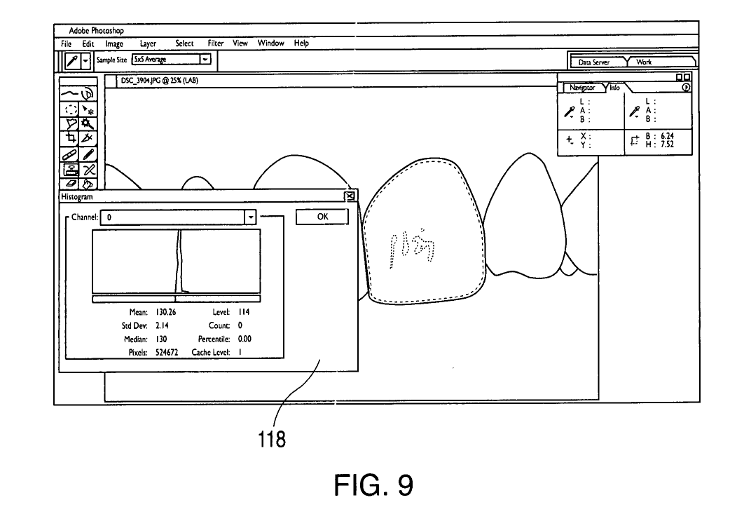

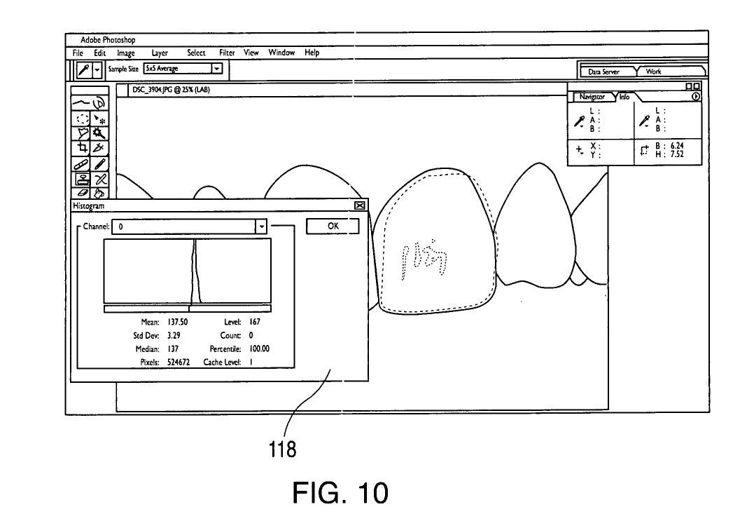

The step-by-step procedure in using ADOBE Photoshop® is as follows:
1. After starting the program, open the INFORMATION menu 104 in the Photoshop® WINDOWS menu; this will provide the color information of each single pixel. See, FIG. 2.
2. Use CTRL+O to open the image 106 to be analyzed. See, FIG. 3.
3. To eliminate an overall color cast, open the Levels dialogue 108 by pressing CTRL+L (or Image, then Adjust, then Levels). A histogram 110 and three eye-dropper tools 112 will appear. The middle one is the gray one (see FIG. 4). Select it and move it over the piece of gray card in the picture. Click again to eliminate the global color cast of the image. This can be controlled by checking the Information panel: the R, G and B values, which would have been slightly different before, will now have the same value. The Lab values will have changed as well: a and b will be set to 0; the L value will not have changed.
4. Change the color space from RGB to Lab. This has to be done for Lab values to be recorded using the histogram of Photoshop®. Also, it provides the advantage that Lab values can be compared with the results of electronic devices that use these same values. If these data are only used for patient information and a comparison with other data is not planned, this step is not necessary: click Image, then Mode, then Lab (see FIG. 5).
5. To obtain images with a comparable brightness, image brightness is compared with a medium value. The brightness of an image is expressed by the L value. By clicking Image then Adjust, then Brightness/Contrast, the overall image brightness can be changed. The brightness level is adjusted to an L value of 54, which is a medium gray value. This sets the brightness of the whole image to a fixed value, which then can be compared with the brightness of other images (see FIG. 6).
6. The tooth to be measured is selected by using the magnetic lasso. The selected tooth will be surrounded by a broken line 114 on the monitor. This line 114 indicates that all measurements refer only to the image content within the line 114 (see FIG. 7). Although the whole tooth is shown to be selected, a representative area of the center, cervical or incisal part may be sufficient so long as the representative area is without opacities or other characteristics such as reflections.
7. Reflections on the tooth surface must be excluded. This can be done easily by the use of the “magic wand”+ALT (or masking mode) to go over the reflections, which are then excluded from analysis with the broken lines 116 (see FIG. 7).
8. L, a, and b values of the selected area are metered by clicking Image, then Histogram (see FIGS. 8-10). The Photoshop® histogram 118 gives information about the mean L, a, and b values, their median, the standard deviation, and the number of pixels that were taken into account.

To transform the Photoshop® Lab values into the Commission Internationale de l'Eclairage (CIE) Lab values, one has to consider that the range of these values is different in both systems. In Photoshop® the range of the mean L value (L(PM)) is 0 to 255. The CIE L value ranges from 0 to 100. By converting Photoshop®'s Lab values into CIE Lab values, results can be compared with other color analysis devices. A transformation can be done by using the following formula:
L=L(PM)× 100/255

Different image editing software may have different ranges of mean L values than Photoshop®. However, one skilled in the art can similarly convert the image editing software's Lab values into the CIE Lab values with a modification of the formula above.

The a and b values are transformed in the same manner. The Photoshop® mean a and b values (a(PM) and b(PM)) range from 0 to 255, and the CIE a and b values range from −120 to +120. The transformation formulas are as follows:
a=(a(PM)−128)× 240/255
b=(b(PM)−128)× 240/255

With regard to tooth-bleaching procedures, the important values for assessment are L, the whiteness of a tooth, b, the yellowness, and a, the redness. After tooth bleaching major changes of the L and b values can be found, whereas the a values show only minor differences. The Δb score (the difference in yellowness before and after bleaching) has the most perceptual relevance. From a clinical point of view the ΔE score, which measures the composite color change and includes the three Lab values, seems to be of minor interest as it is not indicative of an overall color change of the tooth.

Although the procedure above is described with respect to ADOBE Photoshop®, other image-editing software can be used for the method of the present invention.

Results Using the Method of the Present Invention

The method of the present invention provides a simple, fast, inexpensive and highly accurate tooth shade analysis. Compared with electronic devices such as spectrophotometers and colorimeters, using digital photography in accordance with the present invention to assess tooth color and the outcome of the bleaching procedures has an additional advantage in that there are numeric data that can be evaluated as well as an image. The image provides additional information such as color distribution, transparent areas, morphology and surface texture. This is critical to achieving an accurate clinical impression.

Although certain features of the invention have been illustrated and described herein, other better modifications and changes will occur to those skilled in the art. It is, therefore, to be understood that the appended claims are intended to cover all such modification and changes that fall within the spirit of the invention.

1. A method of determining color information of an object utilizing a digital image taken with a digital camera, comprising the steps of:
providing a predetermined fixed environmental and lighting condition for said object;
setting said camera with predetermined fixed settings;
providing a predetermined neutral reference adjacent said object at a predetermined location;
capturing said digital image to include said object and said neutral reference;
providing a commercially available image editing software capable of standardizing and analyzing the digital image;
standardizing said digital image based on said neutral reference using said computer program; and
analyzing the color information of said object using said computer program.

2. The method of claim 1 wherein said digital image is a high resolution digital image.

3. The method of claim 1 wherein said digital camera is a digital SLR camera.

4. The method of claim 1 wherein said predetermined fixed environmental and lighting condition comprises the use of a powerful flash with said camera.

5. The method of claim 1 wherein said predetermined fixed environmental and lighting condition comprises a predetermined room and predetermined room illumination.

6. The method of claim 5 wherein said predetermined room having neutral color walls and ceiling.

7. The method of claim 5 wherein said predetermined room illumination having no natural sunlight.

8. The method of claim 1 further comprising the steps of aligning said camera at a predetermined orientation with respect to said object.

9. The method of claim 1 wherein said predetermined fixed settings of said camera comprises setting said camera to manual exposure mode with a fixed aperture.

10. The method of claim 1 wherein said predetermined fixed settings of said camera comprises setting said camera to aperture priority exposure mode.

11. The method of claim 1 wherein said predetermined fixed settings of said camera comprises setting said camera to matrix metering.

12. The method of claim 1 wherein said predetermined fixed settings of said camera comprises setting said camera to center-weighted metering.

13. The method of claim 1 wherein said predetermined fixed settings of said camera comprises setting said camera to a fixed magnification ratio close to 1:1.

14. The method of claim 1 wherein said predetermined fixed settings of said camera comprises setting said camera to manual flash mode.

15. The method of claim 1 wherein said predetermined fixed settings of said camera comprises setting said camera to a fixed white balance.

16. The method of claim 1 wherein said predetermined fixed settings of said camera comprises setting said camera to a fixed image resolution.

17. The method of claim 1 wherein said predetermined fixed settings of said camera comprises setting said camera to a fixed file type.

18. The method of claim 1 wherein said predetermined fixed settings of said camera comprises setting said camera to the lowest ISO value on said camera.

19. The method of claim 1 wherein said camera comprises a Nikon D100 camera body, a 105 mm AF Mikro Nikkor lens and a Nikon SB29s flash without diffuser, and said predetermined fixed settings of said camera comprises setting said camera to:
a. 1/125s exposure time;
b. F36 aperture;
c. 1:1.2 magnification ratio;
d. flash white balance
e. 0 exposure compensation;
f. jpeg file type;
g. center weighted metering; and
h. 200 ISO setting.

20. The method of claim 1 wherein said predetermined neutral reference is a gray card having a reflectance value of 18%.

21. The method of claim 1 wherein said commercially available image editing software is ADOBE Photoshop®.

22. The method of claim 1 wherein standardizing said digital image further comprising the steps of eliminating color cast of said digital image and fine tuning said digital image by adjusting the brightness.

23. The method of claim 1 wherein the color information of said object is expressed in Lab values.

24. The method of claim 23 wherein the color information of said object is expressed in RGB values.

25. The method of claim 24 further comprising the step of converting said RGB values into Lab values.

26. A method of determining color information of a tooth utilizing a digital image taken with a digital camera, comprising the steps of:
providing a predetermined fixed environmental and lighting condition for said tooth;
setting said camera with predetermined fixed settings;
providing a predetermined neutral reference adjacent said tooth at a predetermined location;
providing a black background behind said tooth;
capturing said digital image to include said object and said neutral reference;
providing a commercially available image editing software capable of standardizing and analyzing the digital image;
standardizing said digital image based on said neutral reference using said computer program; and
analyzing the color information of said tooth using said computer program.
